(19) United States
(12) Patent Application Publication
(10) Pub. No.: US 2024/0012300 A1
(43) Pub. Date: Jan. 11, 2024

(54) DISPLAY DEVICE

(71) Applicant: Japan Display Inc., Tokyo (JP)

(72) Inventor: Yosuke HYODO, Tokyo (JP)

(21) Appl. No.: 18/344,955

(22) Filed: Jun. 30, 2023

(30) Foreign Application Priority Data
Jul. 8, 2022 (JP) 2022-110320

(51) Int. Cl. G02F 1/1347; G02F 1/1335; G02F 1/1362

(52) U.S. Cl. CPC G02F 1/1347; G02F 1/133528; G02F 1/136286

(57) ABSTRACT

A display device including a display panel, and a brightness adjusting panel stacked with the display panel, in which a first polarizing plate is adhered on an incident side of light of the brightness adjusting panel, scanning lines extend in a first direction and are arranged in a second direction, signal lines extend in the second direction and are arranged in the first direction, the signal lines extend in the second direction in repeating bending, a direction of bending tilts 15 degrees or more with respect to a polarizing axis of the first polarizing plate, a light shading film is famed under the signal line via an insulating film along the signal line and overlapping the signal line in a plan view on a same layer as the scanning lines are famed, and a width of the light shading film is larger than a width of the signal line.

### CLAIM OF PRIORITY

The present application claims priority from Japanese Patent Application JP 2022-110320 filed on Jul. 8, 2022, the content of which is hereby incorporated by reference into this application.

### BACKGROUND OF THE INVENTION

### (1) Field of the Invention

The present invention relates to a liquid crystal display device in which a plurality of liquid crystal panels are stacked on top of the other to raise contrast of images.

### (2) Description of the Related Art

A liquid crystal display device has a structure including a TFT substrate, in which pixels having pixel electrodes and TFTs (Thin Film Transistor) are arranged in matrix, a counter substrate opposing to the TFT substrate, and a liquid crystal layer sandwiched between the TFT substrate and the counter substrate. A light transmittance of each of the pixels is controlled by liquid crystal molecules in each of the pixels; thus, images are formed. Liquid crystal display devices are now being used in various fields since liquid crystal display devices can be made small and light.

It is known to dispose a brightness adjusting panel, which controls only brightness, overlapping the display panel to raise a contrast of display images in the liquid crystal display device. That is to say, to shade the back light by brightness adjusting panel at the black area of the images to raise a contrast.

On the other hand, when an axis of polarization angle is tilted, to extending direction of a signal line, a leak of light occurs. In a structure in which a polarization direction of the polarizing plate is tilted from longitudinal direction or lateral direction, the patent document 1 discloses to tilt a contact electrode, which connects a TFT and a pixel electrode to each other, in a direction of the polarization direction to avoid a leak of light with respect to the contact electrode.

### PRIOR ART REFERENCE

[Patent document] Patent document 1: Japanese patent application laid open No. 2009-276485

### SUMMARY OF THE INVENTION

It is necessary to make an electric resistance of the signal line small to keep a writing speed of the data. If a thickness of the signal line is made larger to decrease the resistance of the signal line, a reflection of light from a side surface of the signal line becomes a problem. That is to say, the light from the backlight impinges on the video signal line from various direction, thus the light incident from oblique angle is reflected at the side surface of the video signal line, and goes to a direction of the screen, consequently, contrast of the images is deteriorated.

On the other hand, contrast of images can be improved by using a brightness adjusting panel overlapping the display panel. Sometimes, a pattern of signal lines of the light adjusting panel are made different from a pattern of signal lines of the display panel to avoid a moire formed by interference between the signal lines of the brightness adjusting panel and the signal lines of the display panel. In this case, there is a chance of a leak of light which is not experienced when only a display panel is used.

The reflection by a side surface of the signal line is influenced from an angle between a polarizing axis (or transparent axis) of the polarizing plate and a side surface of the signal line and so forth. There is a chance that an extending direction of the signal line of the display panel and an extending direction of the signal line of the brightness adjusting panel are different, therefore, there is a chance that a reflection, which were not existed when only the display panel were used, is generated in the brightness adjusting panel.

A purpose of the present invention is to suppress a leak of light due to a reflection from a side surface of the signal line in the liquid crystal display device, especially in the liquid crystal display device which uses a brightness adjusting panel, consequently, to realize a liquid crystal display device which can display high contrast images.

The present invention solves the above explained problems; the representative structures are as follows.

(1) A display device including a display panel, which displays images, and a brightness adjusting panel stacked with the display panel, in which a first polarizing plate is adhered on an incident side of light of the brightness adjusting panel, a second polarizing plate is adhered on an exit side of the light of the brightness adjusting panel, scanning lines extend in a first direction and are arranged in a second direction, signal lines extend in the second direction and are arranged in the first direction, the signal lines extend in the second direction in repeating bending, a direction of bending tilts 15 degrees or more with respect to a polarizing axis of the first polarizing plate, a light shading film is formed under the signal line via an insulating film along the signal line and overlapping the signal line in a plan view on a same layer as the scanning lines are formed, and a width of the light shading film is larger than a width of the signal line.

(2) A display device including a display panel, which displays images, and a brightness adjusting panel stacked with the display panel, in which a first polarizing plate is adhered on an incident side of light of the brightness adjusting panel, a second polarizing plate is adhered on an exit side of the light of the brightness adjusting panel, scanning lines extend in a first direction and are arranged in a second direction, signal lines extend in the second direction and are arranged in the first direction, the signal lines extend in the second direction in repeating bending, a direction of bending tilts 15 degrees or more with respect to a polarizing axis of the first polarizing plate, the signal line is formed from a plurality of layers including a first layer, which is a bottom layer, and a second layer, which is a layer formed on the first layer, a width of a top of the first layer is larger than a width of a bottom of the second layer; and provided, a thickness of the signal line is h, a difference in a width of the first layer and a width of a top of the signal line is 2 h/tan 30 or more.

(3) A display device including a display panel, which displays images, and a brightness adjusting panel stacked with the display panel, in which a first polarizing plate is adhered on an incident side of light of the brightness adjusting panel, a second polarizing plate is adhered on an exit side of the light of the brightness adjusting panel, scanning lines extend in a first direction and are arranged in a second direction, signal lines extend in the second direction and are arranged in the first direction, the signal lines extend in the second direction in repeating bending, a direction of bending tilts 15 degrees or more with respect to a polarizing axis of the first polarizing plate, the signal line is formed from a plurality of layers including a first layer, which is a bottom layer, and a second layer, which is a layer formed on the first layer, and a side surface of the signal line tilts 30 degrees or less with respect to a bottom surface of the first layer.

### BRIEF DESCRIPTION OF THE DRAWINGS

FIG. 1 is an exploded perspective view of a display device which includes a brightness adjusting panel;

FIG. 2 is a cross sectional view of FIG. 1 along the line A-A;

FIG. 3 is a cross sectional view of FIG. 1 along the line B-B;

FIG. 4 is a plan view of a liquid crystal display panel;

FIG. 5 is a plan view of a brightness adjusting panel;

FIG. 6 is a plan view of a pixel of the liquid crystal display panel;

FIG. 7 is a cross sectional view of a pixel of the liquid crystal display panel;

FIG. 8 is a plan view of a pixel of the light adjusting panel;

FIG. 9 is a cross sectional view of a pixel of the light adjusting panel;

FIG. 10 is a cross sectional view of FIG. 8 along the line E-E;

FIG. 11 is a cross sectional view of FIG. 8 along the line F-F;

FIG. 12 is a plan view of the pixel in the brightness adjusting panel according to a structure of another example;

FIG. 13 is a cross sectional view of a brightness signal line of normal structure;

FIG. 14 is a cross sectional view of a scanning line;

FIG. 15 is a cross sectional view of a scanning line according to another example;

FIG. 16 is a cross sectional view to show a reflection of light from a side surface of the signal line;

FIG. 17 is a cross sectional view of a structure according to embodiment 1;

FIG. 18 is a cross sectional view of a structure according to another example of embodiment 1;

FIG. 19 is a cross sectional view of a structure according to embodiment 2;

FIG. 20 is a cross sectional view of an interim structure to show a process in embodiment 2;

FIG. 21 is a cross sectional view of an interim structure to show a process following FIG. 20;

FIG. 22 is a cross sectional view of an interim structure to show a process following FIG. 21;

FIG. 23 is a cross sectional view of an interim structure to show a process following FIG. 22;

FIG. 24 is a cross sectional view of a structure according to embodiment 3;

FIG. 25 is a cross sectional view to show a process in embodiment 3; and

FIG. 26 is a cross sectional view to show a process following FIG. 25 in embodiment 3.

### DETAILED DESCRIPTION OF THE PREFERRED EMBODIMENTS

The present invention is explained in detail according to the following embodiments.

### Embodiment 1

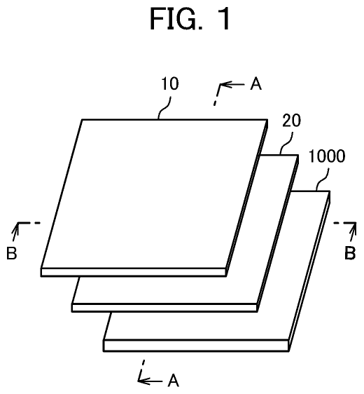

FIG. 1 is an exploded perspective view of a liquid crystal display device according to the present invention. In FIG. 1, a first liquid crystal display panel 10 and a second liquid crystal display panel 20 are stacked on top of the other. A back light 1000 is disposed at the back of the second liquid crystal display panel 20. This structure is sometimes called as a local dimming. That is to say, light is not applied to the area where black is displayed in a display image; consequently, images of high contrast can be formed.

The same liquid crystal display panel can be used for the display panel 10 and the brightness adjusting panel 20, however, in this embodiment, some parts of the structures are made different between the display panel 10 and the brightness adjusting panel 20 to improve brightness and quality of the display images as a total display device. For example, color filter is not used in the brightness adjusting panel 20 to improve brightness of images as a total display device; the structures of signal lines are made different between the display panel 10 and the brightness adjusting panel 20 to avoid generation of moire caused by an interference between the display panel and the brightness adjusting panel 20, and so forth.

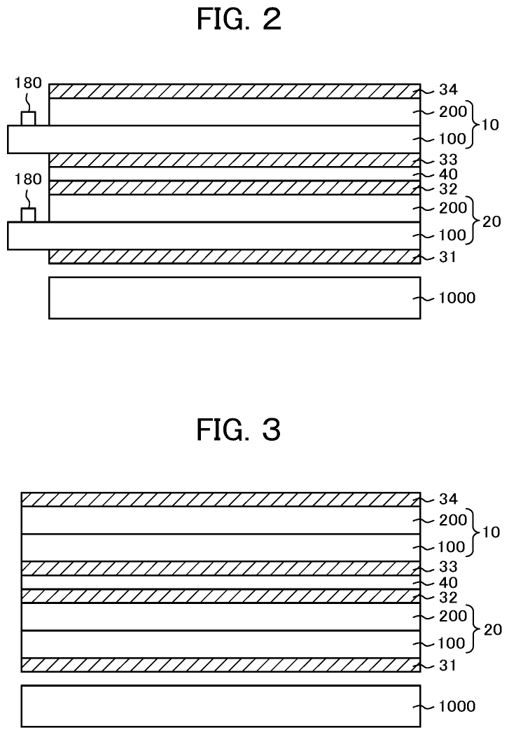

FIG. 2 is a cross sectional view of FIG. 1 along the line A=A when it is assembled. In FIG. 2, the display panel 10, which is disposed at a top, is constituted from a TFT substrate 100, in which wirings and TFTs are formed, and a counter substrate 200; a liquid crystal layer is sandwiched between the TFT substrate 100 and the counter substrate 200; and thus, light from the back light is controlled separately in each of the pixel electrodes. Since the liquid crystal can control only polarized light, a bottom polarizing plate 33 is disposed at the bottom of the display panel 10 and a top polarizing plate 34 is disposed on the display panel 10.

The TFT substrate 100 is made larger than the counter substrate 200, a terminal area is formed in a region where the TFT substrate 100 does not overlap with the counter substrate 200. The driver IC 180 and so forth are formed on the terminal area to drive the display panel. On the other hand, a display area is formed in an area in which the TFT substrate 100 and the counter substrate 200 overlap.

In FIG. 2, the structure of the brightness adjusting panel 20 is the same as the structure of the display panel 10. That is to say, the TFT substrate 100, in which wrings and TFTs and so forth are formed, and the counter substrate 200 opposes to each other, a display area is formed in an area the TFT substrate 100 overlaps the counter substrate 200, and a terminal area is formed in an area the TFT substrate 100 does not overlap the counter substrate 200. The bottom polarizing plate 31 is disposed at the bottom of the TFT substrate 100 and the top polarizing plate 32 is disposed on the counter substrate 200.

A so-called OCA (Optical Clear Adhesive) 40 is used considering optical coupling for adhering between the display panel 10 and the brightness adjusting panel 20, that is to say, adhering between the bottom polarizing plate 33 of the display device 10 and the top polarizing plate 32 of the brightness adjusting panel 20. The OCA 40 is a sheet shaped, and a thickness is, e.g., 100 μm. In FIG. 2, a back light 1000 is disposed at the rear side of the brightness adjusting panel 20.

FIG. 3 is a cross sectional view of FIG. 1 along the line B-B when it is assembled. The structure of FIG. 3 is the same as the structure of FIG. 2 except a terminal area does not exist. That is to say, the brightness adjusting panel 20 is disposed at the rear of the display panel 10; the display panel 10 and the brightness adjusting panel are adhered to each other by the OCA 40. The back light 1000 is disposed at the rear of the brightness adjusting panel 20.

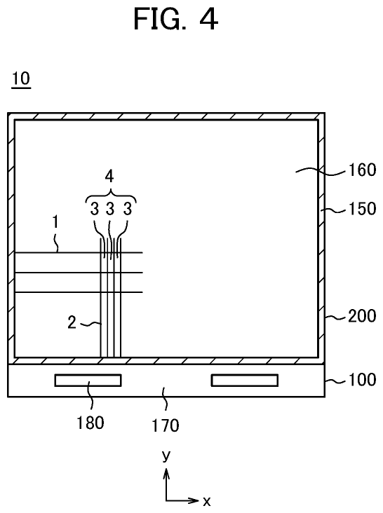

FIG. 4 is a plan view of the display panel 10. In FIG. 4, TFT substrate 100 and the counter substrate 200 are adhered to each other by a seal material 150; the liquid crystal is sandwiched between the TFT substrate 100 and the counter substrate 200. The TFT substrate 100 is made larger than a counter substrate 200, a terminal area 170 is formed in a region of the TFT substrate 100 which does not overlap the counter substrate 200. The IC driver 180 is installed on the terminal area 170. A flexible wiring substrate, which supplies power, video signals, scanning signals and so forth, is connected to the terminal area 170, however, it is not depicted in FIG. 4.

A display area 160 is formed in an area the TFT substrate 100 and the counter substrate 200 overlap with each other. The scanning lines 1 extend in lateral direction (the x direction) and are arranged in longitudinal direction (the y direction). The video signal lines 2 extend in longitudinal direction (the y direction) and are arranged in lateral direction (the x direction). A sub pixel 3 is formed in an area which is surrounded by the scanning lines 1 and the video signal lines 2. The sub pixels 3 become red subpixel, green subpixel and blue subpixel according to the corresponding color filters, and are arranged in lateral direction. A set of a red subpixel 3, a green subpixel 3 and a blue subpixel 3 form a pixel 4. Hereinafter, however, words of subpixel and pixel may be used indistinctively.

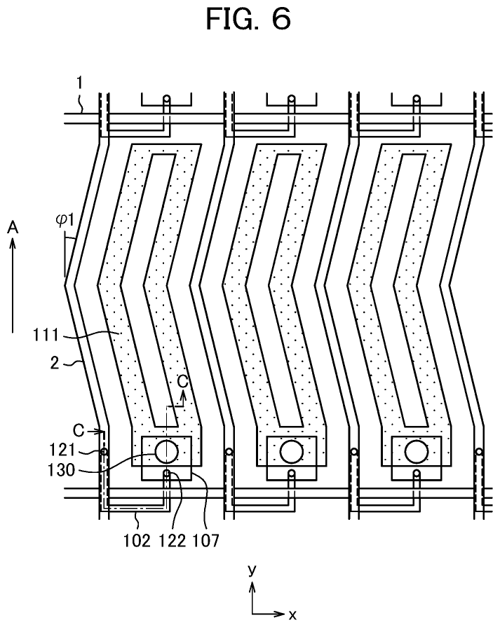

In FIG. 4, the video signal line 2 is drawn as a linear line; however, sometimes it may extend in longitudinal direction repeating bending in chevron shape. In this embodiment, as depicted in FIG. 6, the video signal lines extend in longitudinal direction in chevron shape.

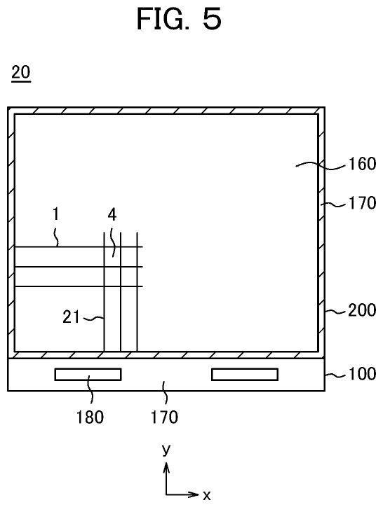

FIG. 5 is a plan view of the brightness adjusting panel 20. The structure of the brightness adjusting panel 20 in FIG. 5 is almost the same as the structure of the display panel 10 explained in FIG. 4; however, wiring structure in the display area 160 is different. In FIG. 5, the scanning lines 1 extend in lateral direction (the x direction) and are arranged in lateral direction (the y direction); the brightness signal lines 21 extend in longitudinal direction and are arranged in lateral direction.

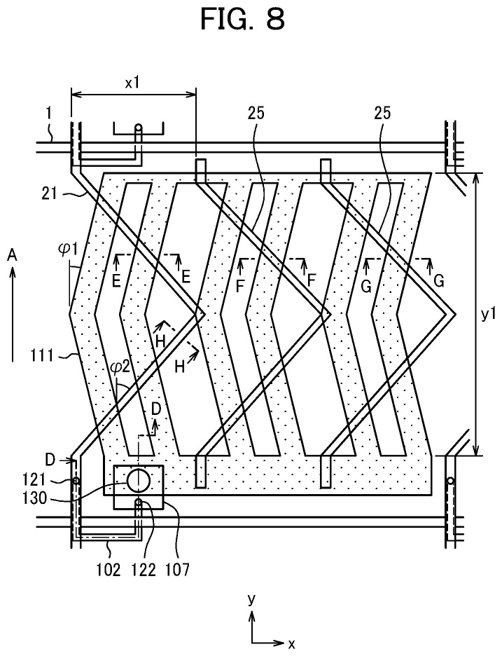

In this embodiment, brightness in the brightness adjusting panel 20 is controlled by pixel. Therefore, a subpixel is not formed in the brightness adjusting panel 20; consequently, a pitch in lateral direction of the brightness signal lines 21 is three times larger compared with a pitch in lateral direction of the video signal line 21 in the display panel 10 in FIG. 4. The brightness signal lines 21 in this embodiment extend in longitudinal direction in repeating bending; as shown in FIG. 8, a bending angle ϕ2 with respect to the y axis of the brightness adjusting line 21 is larger than a bending angle ϕ1 of the video signal lines 2 with respect to the y axis as shown in FIG. 6. Other structures of FIG. 5 are the same as that of FIG. 4.

FIG. 6 is a plan view of a pixel of the display panel 10. The pixel is formed from three subpixels. The structure of the three subpixels is the same. The subpixels become a red subpixel, green subpixel and blue subpixel according to corresponding color filters formed on the counter substrate 200. So-called IPS (In Plane Switching) mode is used in the liquid crystal display panel 10 and in the brightness adjusting panel 20 after FIG. 6 in this embodiment. The IPS mode has superior viewing angle characteristics.

In the IPS mode, a transmittance of the liquid crystal layer is controlled by rotating a direction of the liquid crystal molecules 301. When a direction of rotation of the liquid crystal molecules 301 is not determined, the liquid crystal molecules 301 cannot rotate when a voltage is applied to the pixel electrode, consequently, an uncontrollable region, so-called a domain, is generated. The pixel electrode is formed in tilting with respect to the y axis to avoid a generation of the domain. The bending direction changes a direction at approximately a center of the pixel electrode in the y axis to make the viewing angle uniform.

In FIG. 6, an alignment direction of the alignment film is in the y axis direction as shown by the arrow A. In this embodiment, a polarizing direction of the bottom polarizing plate and an alignment direction of the alignment film are the same. The angle ϕ1 to suppress a generation of the domain is 8 to 13 degrees with respect to the y axis.

In FIG. 6, the video signal lines 2 also repeat bending with respect to the y axis according to the bending of the pixel electrodes 111. In FIG. 6, video signals are sent from the video signal line 2 to the pixel electrode 111 through the TFT. The semiconductor film 102 is formed in U shape in a plan view to form the TFT. In FIG. 6, a TFT is formed when the semiconductor film 102 passes under the scanning line 1. Consequently, two TFTs are formed in FIG. 6.

In FIG. 6, the video signal line 2 also serves as a drain electrode of the TFT and the scanning line 1 also serves as gate electrode of the TFT. The video signal line 2 is connected with the semiconductor film 102 via through hole 121. The semiconductor film 102 is made conductive by doping, e.g., phosphorous by ion implantation (I.I.) except under the scanning line 1. Another terminal of the semiconductor film 102 is connected with the source electrode 107 via trough hole 122. The source electrode 107 is connected with the pixel electrode 111 via the through hole 130 formed in the organic passivation film. A diameter of the through hole 130 is large because it is formed in a thick organic passivation film.

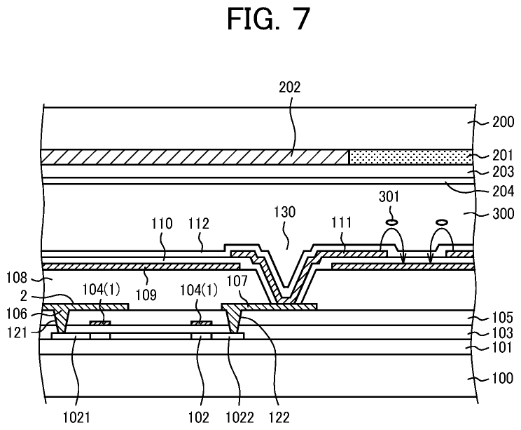

FIG. 7 is a cross sectional view of FIG. 6 along the line C-C. In FIG. 6, an under layer 101 is formed on the TFT substrate 100, formed by, e.g., glass. The under layer 101 prevents the semiconductor film 102, which is formed later, from being contaminated by impurities from the glass. The under layer 101 has generally a two layer structure of a silicon nitride film (herein after SiN film) and a silicon oxide film (herein after SiO film). A semiconductor film 102 is formed on the under layer 101. The semiconductor film 102 is formed as that: an a-Si (amorphous Silicon) film is formed by CVD (Chemical Vapor Deposition), and then, the a-Si film is transformed to a poly silicon film by applying excimer laser. In the meantime, the SiN film and the SiO film, which constitute the under layer 101 and the a-Si film which is to be a semiconductor film 102 are formed continuously by CVD.

After patterning the semiconductor film 102, a gate insulating film 103 is formed covering the semiconductor film 102. The gate insulating film 103 is a SiO film formed from TEOS (Tetra Ethoxy Silane) as material. A gate electrode 104 is formed on the gate insulating film 103. The gate electrode 104 is formed from MoW (Molybdenum-Tungsten) alloy by sputtering, and then, the gate electrode 104 is patterned. In the structure of FIG. 6, the scanning line 1 also serves as a gate electrode 104; two TFTs are formed when the semiconductor film 102 passes under scanning line 1 twice; therefore, in FIG. 7, two gate electrodes 104 are formed in FIG. 7.

After pattering the gate electrode 104, an ion implantation of, e.g., Phosphorous, Boron and so forth is made to give conductivity to the semiconductor film 102 except under the scanning line 104. Consequently, a drain region 1021 and a source region 1022 are formed in the semiconductor film 102.

After that, an interlayer insulating film 105 is formed covering the gate electrode 104 by SiO film or a SiN film, or a laminated film of a SiO film and a SiN film. The interlayer insulating film 105 can be formed by CVD. The video signal line 2 and the drain region 1021 of the semiconductor film 102 are connected via through hole 121 formed in the interlayer insulating film 105 and the gate insulating film 103. In this case the video signal line 2 becomes a drain electrode 106. On the other hand, the source region 1022 of the semiconductor film 102 is connected with the source electrode 107 via the through hole 122 formed in the interlayer insulating film 105 and the gate insulating film 103.

An organic passivation film 108 is formed, by, e.g., acrylic resin, covering the drain electrode 106 and the source electrode 107. The organic passivation film 108 also works as a flattening film, therefore, it is made thick as 2 to 4 μm. The organic passivation film 108 can be formed from silicone resin, polyimide and so forth as well as acrylic resin.

A common electrode 109 is formed on the organic passivation film 108 in a plane shape by transparent oxide conductive film as ITO (Indium Tin Oxide). The common electrode 109 is formed in common in pixel electrodes; however, it is not formed in the through hole 130. After patterning the common electrode 109, a capacitance insulating film 110 is formed from SiN covering the common electrode 109. The capacitance insulating film 110 is formed by CVD. Since the capacitance insulating film 110 is formed after the organic passivation film 108 is formed, a high temperature CVD cannot be used, therefore, a low temperature CVD, which is performed at approximately 200 degrees Celsius, is used.

A pixel electrode 111 is formed from a transparent oxide conductive film as ITO on the capacitance insulating film 110 in a stripe shape or a comb shape. The insulating film 110 between the common electrode 109 and the pixel electrode 111 forms a storage capacitance between the pixel electrode 111 and the common electrode 109, therefore, it is called as a capacitance insulating film 110.

A through hole is formed in the capacitance insulating film 110 in the through hole 130 in the organic passivation film 108 to connect the pixel electrode 111 and the source electrode 107 with each other.

An alignment film 112 is formed covering the pixel electrode 111 and the capacitance insulating film 110. The alignment film 112 determines an intimal alignment direction of the liquid crystal molecules 301; alignment process is made through a rubbing process or an optical alignment process. In the IPS mode, the optical alignment process is suitable. When a voltage is applied to the pixel electrode 111, a line of force is generated between the pixel electrode 111 and the common electrode 109 as shown by an arrow in FIG. 7 to rotate liquid crystal molecules 301; consequently, a transmittance of the liquid crystal layer 300 is controlled in every pixels, thus, images are formed.

The counter substrate 200 is disposed opposing to the TFT substrate 100 sandwiching the liquid crystal layer 300. Color filter 201 and a light shading layer 202 are formed on inside of the counter substrate 200. The color filter 201 is disposed in regions to form color images by controlling the light from the back light. On the other hand, a light shading layer 202 is formed in a region, in which it is difficult to control the light from the back light, e.g., corresponding to like a region in which a through hole 130 and so forth are formed; thus, a leak of light is prevented.

An overcoat film 203 is formed from transparent resin as acrylic covering the color filter 201 and the light shading layer 202 on the inside of the counter substrate 200. An alignment film 204 is formed on the overcoat film 203. The alignment process for the alignment film 204 is made through rubbing process or optical alignment process, the same as for the alignment film 112.

FIG. 8 is a plan view of the pixel of the brightness adjusting panel 20. The pixel electrode 111 is formed in a same shape and at the same location as the subpixels formed in the display panel in the plan view. That is to say, the pixel electrode 111 tilts compared with the y axis with an angle of ϕ1. The pixel electrode 111, however, is connected in common in the pixel because a light transparency is controlled for each pixel in the light adjusting panel 20. Therefore, only one brightness signal line 21 is needed for each of the pixel.

The brightness signal line 21 bends in FIG. 8 by an angle of ϕ2; the bending angle ϕ2 of the brightness signal line 21 is larger than the bending angle ϕ1 of the video signal line 2 to make an influence of the brightness signal line 21 of the light adjusting panel uniform in a subpixel of the display panel 10. In FIG. 8, provided, a width of the subpixel is x1, a length of the pixel electrode at the comb shape along the y axis is y1, tan ϕ2=x1/(y1/2) and ϕ2>ϕ1.

As described above, the brightness signal line 21 is formed only in a subpixel located at lefthand side. Then, a difference in brightness is generated between the lefthand side subpixel and the other two subpixels. In order to avoid this problem, in FIG. 8, a dummy signal line 25 is formed in each of the two subpixels. Brightness signal, however, is not supplied to the dummy signal lines the dummy signal lines 25 is float in FIG. 8. Since the purpose of the dummy signal line 25 is only for light shading, the structure of the dummy signal line 25 is preferably simple. For example, the dummy signal line 25 can be formed on a same layer as the scanning line 1 and formed from the same structure of the scanning line 1 or if the scanning line 1 is formed by plural layers, the dummy signal line 25 can be formed from only one layer among the plural layers of the scanning line 1.

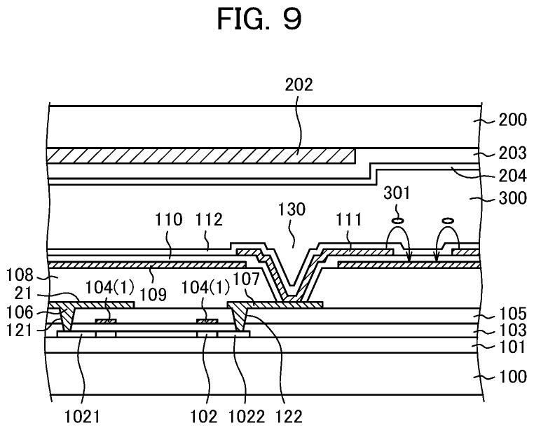

FIG. 9 is a cross sectional view of FIG. 8 along the line D-D, in which the structure of the TFT is shown. The structure of the TFT in the brightness adjusting panel 20 is the same as the structure of the TFT in the display panel 10. That is to say, FIG. 9 is the same as FIG. 7, which is a cross sectional view of FIG. 6 along the line C-C. In FIG. 9, however, the brightness signal line 21 is formed instead of the video signal line 2. On the other hand, on the counter substrate 200, color filter is not formed at the region corresponding to the pixel electrode 111 in FIG. 9, which is different from FIG. 7 because the purpose of the brightness adjusting panel 20 is to control only brightness of the screen to raise a contrast of the images. Other structures of FIG. 9 are the same as that of FIG. 7.

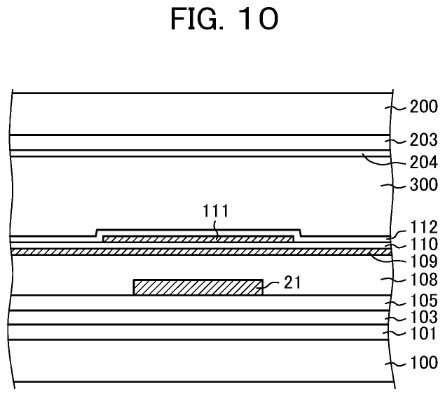

FIG. 10 is a cross sectional view of FIG. 8 along the line E-E, in which the brightness signal line 21 is formed. The basic structure of FIG. 10 is the same as the structure explained in FIGS. 7 and 9. In FIG. 10, the brightness signal line 21 is formed on the interlayer insulating film 105. The pixel electrode 111 is formed in a region corresponding to the brightness signal line 21.

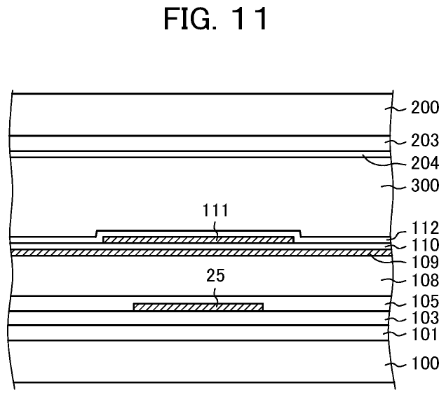

FIG. 11 is a cross sectional view of FIG. 8 along the line F-F, which is a cross sectional structure of the subpixel in which the brightness signal line is not formed, however, the dummy signal line 25 is formed instead. In FIG. 11, the dummy signal line 25 is formed on the same layer as the scanning line 1 is formed. The dummy signal line 25 can have the same layer structure as the scanning signal line1 1 or can be formed from one layer among the plural layers of the scanning line 1. The pixel electrode 111 is formed at the region corresponding to the dummy signal line 25. Cross sectional view of the line G-G is the same as FIG. 11.

The light shading effect with respect to the back light is the same between FIG. 10 and FIG. 11; that is to say, the three subpixels in FIG. 8 receive the same light shading effect. In the meantime, the word of dummy signal line is used in this specification, however, a signal is not supplied to the dummy signal line 25. The word of the dummy signal line is used because an outer shape of the dummy signal line 25 is made resemble to the shape of the brightness signal line 21; however, another word of, e.g., light shading film can be used instead.

By the way, the structure of the pixel electrode 111 in FIG. 8 in the brightness adjusting panel 20 has the same structure as the corresponding pixel electrode 111 in FIG. 6 in the display panel 10. In the brightness adjusting panel 20, however, the subpixels are not distinguishable, and brightness is controlled in common in one pixel, therefore, the pixel electrode 111 in the brightness adjusting panel 20 is not necessarily completely the same as the pixel electrode 111 in the display panel 10.

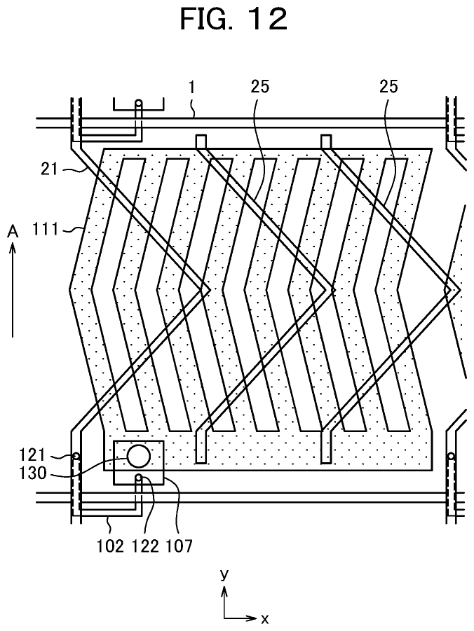

FIG. 12 is an example, in which comb portion of the pixel electrode 111 is distributed uniformly in the area of the pixel. In this case, too, however, a plan view of the brightness signal line 21 and a plan view of the dummy signal line 25 are the same of those in FIG. 8. The brightness adjusting panel 20 of FIG. 12 has the same effect as that of the brightness adjusting panel 20 of FIG. 8; however, explanations below are made based on the structure of FIG. 8.

A problem in the brightness adjusting panel 20 in FIG. 8 is as follows. That is to say, a leak of light occurs at a side surface of the brightness signal line 21. On the other hand, such problem does not occur in the dummy signal lines 25. In addition, such a problem does not occur in the scanning line 1 either. Further, such problem does not occur in the video signal line 2, the scanning line 1, and so forth in the display panel 10.

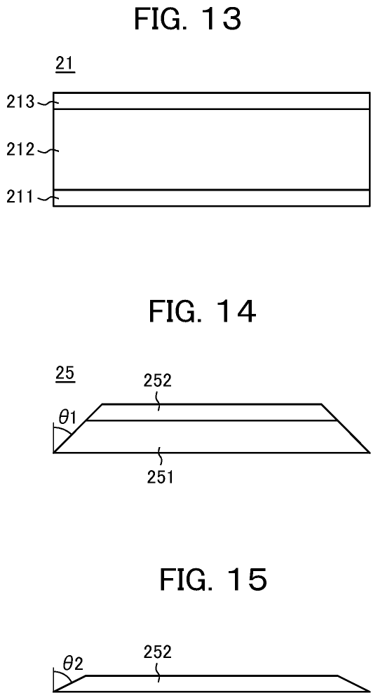

FIG. 13 is a cross sectional view of the brightness signal line 21 in FIG. 8. A resistance of the brightness signal line 21 must be small to write signals in high speed. In FIG. 13, the resistance of the brightness signal line 21 is made small by using aluminum (Al), which has small electrical resistance, in a thickness of 500 μm. On the other hand, since aluminum oxide is formed on a surface of the aluminum, Ti (Titanium) is formed in a thickness of 50 nm as a base metal 211 at the bottom of the aluminum film 212. On the other hand, there is a chance that a hillock is generated on a surface of the aluminum, and electrical insulation is broken; in order to avoid this problem, a film of titanium (Ti) is formed as a cap metal 213 in a thickness of 50 nm on a top of the aluminum film 212. When the base metal 211 is called a first layer, the aluminum is called a second layer 212 and the cap metal 213 is called a third layer, a total thickness from the first layer to the third layer becomes 600 nm.

On the other hand, the scanning line 1 of FIG. 8 has a two-layer structure, in which the top layer is formed from molybdenum (Mo) and the bottom layer is formed from molybdenum alloy. FIG. 14 is a cross sectional view of the scanning line 1, in which a thickness of the molybdenum (Mo) layer as the top layer 252 is 45 nm, and a thickness of Mo alloy layer as the base layer 251 is 210 nm; a total thickness of the top layer 252 and the bottom layer 251 is 255 nm. A taper angle θ1 at the edge is 20 to 30 degrees.

The dummy signal line 25 in FIG. 8 may have the same structure as scanning line 1 or may be made from only Mo layer 252, which is a top layer of the scanning line 1. FIG. 15 is a cross sectional view of the dummy signal line 25 in which the dummy signal line 25 is formed from only Mo, which is the same as the top layer of the scanning line 1. In FIG. 15, a thickness of the dummy signal line 25 is 45 nm and a taper angle θ2 at the edge is 20 to 30 degrees.

FIG. 13 through FIG. 15 show a cross sectional views of the wirings in the brightness adjusting panel 20; however, cross sectional views in the display panel 10 are the same. That is to say, a cross sectional view of the video signal line 2 in the display panel 10 is the same as FIG. 13; a cross sectional view of the scanning line 1 in the display panel 10 is the same as FIG. 14.

A leak of light from the back light occurred only at the brightness signal line 21 in the brightness adjusting panel 20 among the structures of the above explained wirings. It is explained as below. The alignment direction of the alignment film 112 in FIG. 8 is the same as a polarizing axis of the polarizing plate 31. An angle ϕ2 formed between the brightness signal line 21 and the alignment direction in FIG. 8 is larger than an angle ϕ1 formed between the video signal line 2 and the alignment direction in FIG. 6. That is to say, when an angle formed between the signal line 21 and the polarizing angle of the polarizing plate 31 (namely, an alignment direction of the alignment film) becomes larger, a disturbance in polarization in the light reflected at the side surface of the signal line occurs, thus, a leak of light is generated.

On the other hand, a leak of light does not occur at the dummy signal line 25 even an angle formed between the wring and the direction of the polarizing axis of the polarizing plate 31 is large. This is supposed as that a thickness of the dummy signal line 25 is thin, thus an amount of light reflected at the side surface of the dummy signal line 25 is small. However, when the dummy signal line 25 is formed from the same structure as the scanning line 1, a thickness of the dummy signal line 25 becomes 255 nm. In this case, however, a taper angle θ1 at the edge of the dummy signal line 25 is 15 to 30 degrees. As described above, one major reason why a leak of light does not occur even the dummy signal line 25 is made thick, is that there is a taper angle θ1 at the edge of the dummy signal line 25.

Theoretically, the light from the back light is incident with an angle smaller than an angle of θ1, a reflection occurs at a side surface of the signal line. The light from the back light, however, has a light distribution angle, and an amount of light of higher angle than certain angle, becomes substantially small. If a light reflected from a side surface of the signal line is so small that it is not visible for the eyes of the human beings, a problem of leak of light is not actually generated.

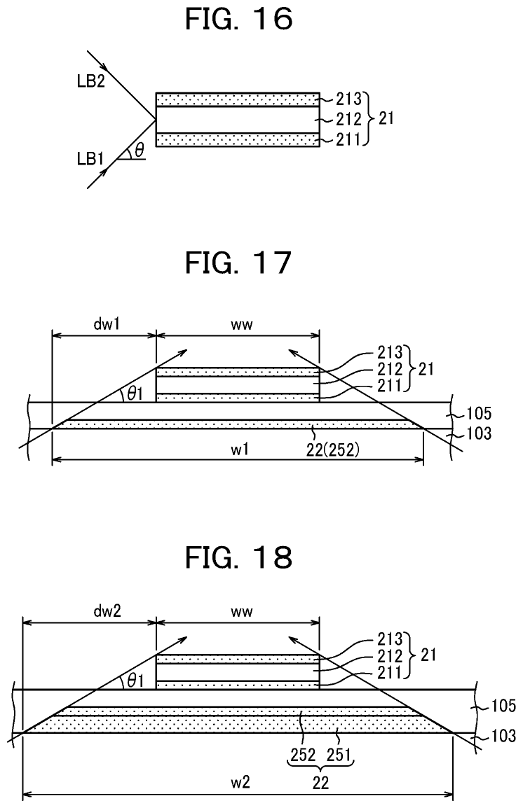

FIGS. 16 to 18 are cross sectional views of concrete structures according to embodiment 1 which is a cross sectional view of the brightness signal line 21 corresponding to FIG. 8 along the line H-H. FIG. 16 is a cross sectional view of the brightness signal line 21 before embodiment 1 is applied. In FIG. 16, the light incident to a side surface of the brightness signal line 21 is reflected and deteriorates the contrast. Especially, when an angle ϕ2 between an extending direction of the brightness signal line 21 and the direction of the polarizing axis becomes larger, a disturbance in polarization in the reflected light occurs, thus, an influence of the leak of the light becomes further larger.

An influence of the disturbance in polarization in the reflected light is small when an angle ϕ1 between the extending direction of the signal line and the polarization direction of the polarizing plate is up to 13 degrees, as shown in FIG. 6. That is to say, a leak of light due to a disturbance in polarization in the reflected light is not observed. However, as shown in FIG. 8, when a bending direction becomes larger, as e.g., ϕ2, an influence of the disturbance in the polarization in the reflected light becomes conspicuous. Considering those phenomena, a disturbance in polarization in the reflected light must be considered when an angle between the signal line and the polarization direction of the polarizing plate becomes 15 degrees or more.

In other words, when an angle between the bending direction of the brightness signal line 21 and the direction of the polarizing axis of the polarizing plate is expected to be 15 degrees or more, a reflection from the side surface of the signal line as depicted in FIG. 16 should be suppressed as less as possible. However, it is impossible to make zero of the reflection light from the side surface of the brightness signal line 21. Therefore, as explained in referring to FIG. 13 through FIG. 15, a leak of light due to an influence of a disturbance in polarization can be substantially suppressed by making an angle θ of the light with respect to a major surface of the brightness signal line 21 in 30 degrees or less. The reason is, that is to say, because a light from the back light has a certain light distribution angle.

FIG. 17 is a cross sectional view of the structure to suppress a light which has an angle 191 in a value of 30 degrees or larger with respect to a major surface of the brightness signal line 21 by forming a light shading film 22 made from Mo film 202 in a thickness 45 nm, which is the same as the dummy signal line 25, on the gate insulating film 103. In FIG. 17, a width of the light shading film 22 becomes wider than a width of the brightness signal line 21 in a value of dw1 in one side. In this case, provided, a total thickness of the interlayer insulating film 105 and the light shading film 22 is 100 nm, and a thickness of the brightness signal line is 600 nm, since tan 30 is the value of dw1 is defined as dw1=700/0.577=1213 nm, that is to say, the width becomes 1.2 μm larger in one side; namely, a light transmittance decreases. Whether this value is a problem or not depends from what value of a width ww of the brightness signal line 21; however, in most cases it is allowable except it is a high-definition display device.

FIG. 18 is a cross sectional view of the structure in which a light shading film 22 is formed from two-layer structure as the same cross-sectional structure as the scanning line 1, namely, the Mo layer 252 and the Mo alloy layer 251 on the gate insulating film 103. That is to say, FIG. 18 is a cross sectional view of the structure to suppress a light which has an angle of 30 degrees or larger with respect to a major surface of the brightness signal line 21. In FIG. 18, a width of the light shading film 22 becomes wider than a width of the brightness signal line 21 in a value of dw2 in one side and a value of 2dw2 in total of both sides. In FIG. 18, a thickness of the light shading film 22 is 255 nm, which is larger than a thickness of the light shading film 22 in FIG. 17. In this case, provided a total thickness of the interlayer insulating film 105 and the light shading film 22 is 300 nm, and a thickness of the brightness signal line 21 is 600 nm, since tan 30 is 0.577, the value of dw2 is defined as dw2=900/0.577=1559 nm, that is to say, the width becomes 1.55 μm larger in one side; namely, a light transmittance decreases. Whether this value is a problem or not depends from what value of a width ww of the brightness signal line 21; however, in most cases it is allowable except it is a high-definition display device.

In cases of FIG. 17 and FIG. 18, a light shading by the brightness controlling line 21 is essentially defined by a width of the light shading film 22. That is to say, a light transmittance in the pixel in FIG. 17 is determined by a width w1 of light shading film 22, which is wider than a width of the brightness signal line 21. In this case, a width of the dummy signal line 25 is determined in accordance with a width w1 of the light shading film 22, not a width ww of the brightness signal line 21. As the same token, a light transmittance in the pixel in FIG. 18 is determined by a width w2 of light shading film 22, which is wider than a width of the brightness signal line 21. In this case, a width of the dummy signal line 25 is determined in accordance with a width w1 of the light shading film 22, not a width ww of the brightness signal line 21.

### Embodiment 2

In embodiment 1, reflection of light, which has a larger angle than a certain value with respect to a major surface of the brightness signal line 21, from a side surface of the brightness signal line 21 is suppressed by forming a light shading film 22 under the brightness signal line 21. In embodiment 2, reflection of light, which has a larger angle than a certain value with respect to a major surface of the brightness signal line 21, from a side surface of the brightness signal line 21 is suppressed by a cross sectional structure of the brightness signal line 21 itself.

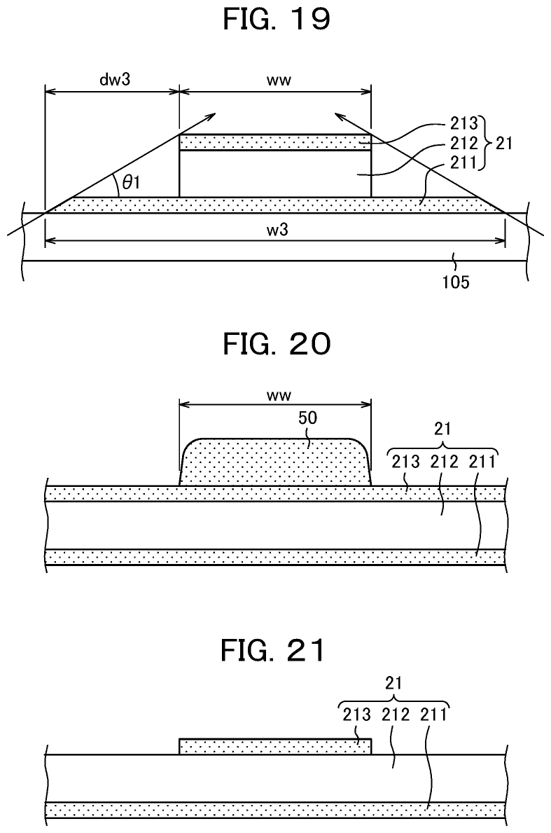

FIG. 19 is a cross sectional view of the brightness signal line 21 according to embodiment 2. A bending angle of the brightness signal line 21 with respect to a direction of the polarizing axis is 15 degrees or more, the light which is influenced is the light incident 30 degrees or more with respect to a major surface of the brightness signal line 21, and so forth are the same as explained in embodiment 1.

In FIG. 19, the cross sectional view of the brightness signal line 21 is the same as the cross sectional view of embodiment 1 in that a titanium (Ti) film of a thickness of 50 nm as a base metal is formed under the aluminum film 212 of a thickness of 500 nm, and a titanium (Ti) film of a thickness of 50 nm as a cap metal is formed on the top the aluminum film 212. The feature of FIG. 19 is essentially to suppress reflecting light from a side surface of the aluminum film 212 and a side surface of the cap metal 213 by only the cross-sectional structure of the brightness signal line 21, not using a light shading film.

In FIG. 19, a width of a first layer, which is a titanium (Ti) film, is larger than a width of the original brightness signal line 21 by wd3 in one side and by 2wd3 in total of both sides. Since a thickness of the brightness signal line 21 is 600 nm in total, dw3=600/tan 30=1040 nm, namely, 1 μm larger in one side. As described above, an actual increase in a width in a brightness signal line 21 can be mitigated in embodiment 2 compared with in embodiment 1. Whether this value is a problem or not depends from what value of a width ww of the brightness signal line 21; however, in most cases it is allowable except it is a high-definition display device.

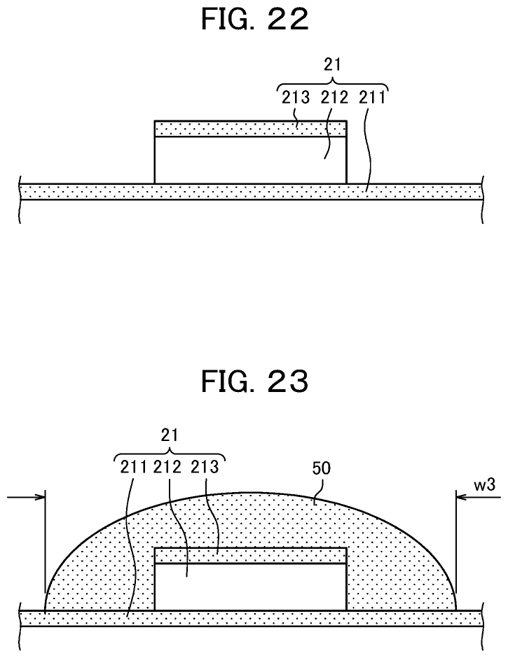

FIGS. 20 to 23 are cross sectional views in an example of the manufacturing process to form a structure of FIG. 19. FIG. 20 is a cross sectional view in which a resist 50 is formed in a width of ww to define a width of the aluminum film, which constitutes an essential part of the brightness signal line 21. FIG. 21 is a cross sectional view in which the cap metal 213, which is formed from titanium (Ti), is patterned with the resist 50 in FIG. 20. FIG. 22 is a cross sectional view in which the aluminum film 212 is patterned in using the cap metal 213 as a resist. FIG. 23 is a cross sectional view in which the resist 50 is formed in a width of w3 to pattern the base metal, which is formed from titanium (Ti) and has an essential role as a light shading film. When titanium (ti) film as the base metal 211 is etched, the brightness signal line 21 of embodiment 2 shown in FIG. 19 is formed.

The above explanation is made that the brightness signal line has a three layer structure, however, the present invention can be applied to the brightness signal line having a two layer structure or a four or more layer structure.

### Embodiment 3

In embodiment 3, reflection of light, which has an angle of 30 degrees or more with respect to a major surface of the brightness signal line 21, from a side surface of the brightness signal line 21 is suppressed by tapering the side surface of the of the brightness signal line 21. That is to say, a bending angle of the brightness signal line 21 with respect to a direction of the polarizing axis is 15 degrees or more, the light affected is incident with an angle of 30 degrees or more with respect to a major surface of the brightness signal line 21, and other structures are the same as explained in embodiment 1.

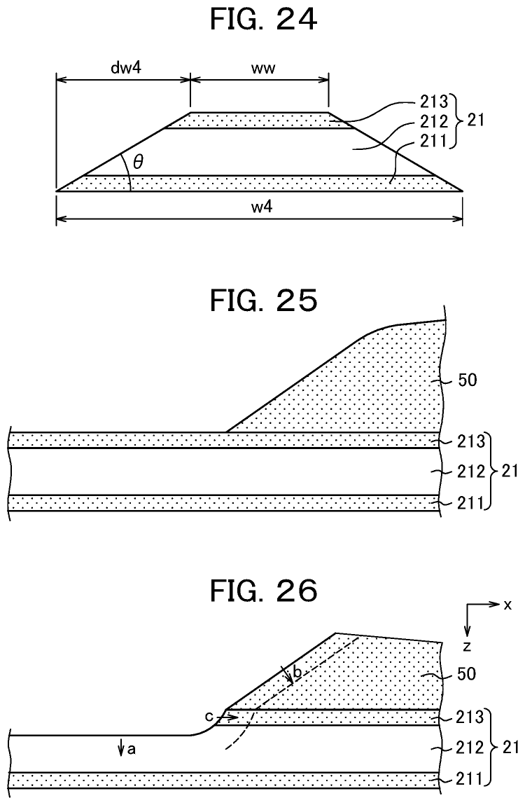

In FIG. 24, the cross-sectional view of the brightness signal line 21 is the same as the cross-sectional view of embodiment 1 in that a titanium (Ti) film of a thickness of 50 nm as a base metal 211 is formed under the aluminum film 212 of a thickness of 500 nm, and a titanium (Ti) film of a thickness of 50 nm as a cap metal 213 is formed on the top of the aluminum film 212. As shown in FIG. 24, the light crosses a major surface of the brightness signal line 21 with an angle of 30 degrees or more does not reflect at a surface of the brightness signal line 21. Therefore, a leak of light due to a disturbance of polarization can be suppressed. In the meantime, the above theory is applicable to a two-layer structure or a four-or more layer structure as well as to a three-layer structure in brightness signal line 21.

The structure shown in FIG. 24 can be realized by etching with retreating the resist 50. FIG. 25 and FIG. 26 are the cross-sectional views to show a concept of the process. In FIG. 25, a resist 50 having tapering is formed for patterning the brightness adjusting signal line 21 which is a laminated structure of the base metal 211, the aluminum film 212 and a cap metal 213.

FIG. 26 is a cross sectional view of interim process in which dry etching, e.g., with oxygen plasma, is performed using the resist Since the resist 50 is tapered, during the dry etching, the resist is also etched in a direction b as well as the metal layer is etched in a direction a. Therefore, the resist 50 retreats in a direction c at the edge, namely, the resist 50 retreats in the x axis direction.

Consequently, the metal layer is etched not only in a direction a, which is the z axis direction, but also is etched in a direction c, which is the x axis direction. As a result, a taper is formed in the side surface of the brightness signal line 21 in a cross-sectional view as shown in FIG. 24.

As explained in embodiments 1 through 3, the present invention is specifically effective when the bending direction of the brightness signal line 21 is 15 degrees or more with respect to a direction of the polarizing axis. It is because an influence of disturbance in polarization occurs in this range. On the other hand, when a direction of the brightness signal line 21 approaches to 90 degrees with respect to a direction of the polarizing axis, an influence of disturbance in polarization disappears. Therefore, the present invention is specifically effective when a bending direction of the brightness signal line is between 15 degrees and 75 degrees with respect to a direction of polarizing axis.

In the above explanations, an angle with respect to the polarizing axis can be defined as the polarizing axis in a polarizing plate on a side in which the light is incident. Further, in the above explanations, the brightness adjusting panel 20 is disposed in the rear the display panel 10; however, on the contrary, the present invention is applicable when the brightness adjusting panel 20 is disposed in front of the display panel 10.

As described above, according to the present invention, a leak of light due to reflection from the side surface of the brightness signal line 21 can be suppressed even when the brightness signal line 21 is bent in an optional direction in the brightness adjusting panel. Therefore, image of high contrast can be realized.

What is claimed is:

1. A display device including a display panel, which displays images, and a brightness adjusting panel stacked with the display panel,
wherein a first polarizing plate is adhered on an incident side of light of the brightness adjusting panel, a second polarizing plate is adhered on an exit side of the light of the brightness adjusting panel,
scanning lines extend in a first direction and are arranged in a second direction, signal lines extend in the second direction and are arranged in the first direction,
the signal lines extend in the second direction in repeating bending,
a direction of bending tilts 15 degrees or more with respect to a polarizing axis of the first polarizing plate,
a light shading film is foamed under the signal line via an insulating film along the signal line and overlapping the signal line in a plan view on a same layer as the scanning lines are foamed, and
a width of the light shading film is larger than a width of the signal line.

2. The liquid crystal display device according to claim 1,
wherein the light shading film is foamed as the same structure as the scanning lines.

3. The display device according to claim 1,
wherein each of the scanning lines is foamed from a plurality of layers, and the light shading film is fainted from a material of one layer of the scanning lines.

4. The display device according to claim 1,
provided a distance between a bottom of the light shading film and a top of the signal line is h, a difference in a width of the signal line and a width of the light shading film is 2 h/tan 30 or more.

5. The display device according to claim 1,
wherein a direction of bending tilts larger than 15 degrees with respect to a polarizing axis of the first polarizing plate,

6. A display device including a display panel, which displays images, and a brightness adjusting panel stacked with the display panel,
wherein a first polarizing plate is adhered on an incident side of light of the brightness adjusting panel, a second polarizing plate is adhered on an exit side of the light of the brightness adjusting panel,
scanning lines extend in a first direction and are arranged in a second direction, signal lines extend in the second direction and are arranged in the first direction,
the signal lines extend in the second direction in repeating bending,
a direction of bending tilts 15 degrees or more with respect to a polarizing axis of the first polarizing plate,
the signal line is famed from a plurality of layers including a first layer, which is a bottom layer, and a second layer, which is a layer foamed on the first layer, and
a side surface of the signal line tilts 30 degrees or less with respect to a bottom surface of the first layer.

7. The display device according to claim 6,
wherein a thickness of the second layer is larger than a thickness of the first layer, and
the second layer is foamed from a plurality of layers.

8. The liquid crystal display device according to claim 6,
provided, a thickness of the signal line is h,
a difference in a width of the first layer and a width of a top of the signal line is 2 h/tan 30 or more.
